(19) United States
(12) Patent Application Publication
(10) Pub. No.: US 2012/0203765 A1
(43) Pub. Date: Aug. 9, 2012

(54) ONLINE CATALOG WITH INTEGRATED CONTENT

(75) Inventors: Nathan Ackerman, Seattle, WA (US); Danny Bauman, Redmond, WA (US); Shane M. DeSeranno, Snohomish, WA (US)

(73) Assignee: MICROSOFT CORPORATION, Redmond, WA (US)

(21) Appl. No.: 13/021,213

(22) Filed: Feb. 4, 2011

(51) Int. Cl. G06F 17/30

(52) U.S. Cl. 707/722; 707/E17.014

(57) ABSTRACT

Systems and methods for integrating third-party content and first-party content in a marketplace environment for presentation to a user of a computing device are provided. The method may include receiving content and publisher-specific metadata from a plurality of third-party publishers; storing the content and publisher-specific metadata in a catalog database. The database may include third-party publisher content and first-party content. The method may further include receiving a catalog query from a client device, identifying a set of catalogs to which a user of the client device belongs; generating query results, the query results including third-party publisher content and first-party content; filtering query results based on the metadata and set of catalogs; and sending the filtered query results to the client device for display on the client device.

### BACKGROUND

Digital assets and content, e.g., applications, music, videos, games, etc., may be offered to users of computing devices such as cell phones, PDAs (personal digital assistants), mobile devices, personal computers, etc., by third-party publishers. For example, mobile operators, which operate the access networks to which mobile computing devices wirelessly connect to enable them to communication with the Internet, may also in some instances desire to make content available to their user base as a third-party publisher, as may a device manufacturer, such as a cell phone handset manufacturer, etc. Additionally, manufacturers of operating systems running on the computing devices may provide access to general content for users of the devices, and may operate an online marketplace from which content from the operating system manufacturer itself, as well as from the third party publishers, may be downloaded by users.

One drawback of these online marketplaces, however, is that when a vast array of content is made available, it can sometimes be difficult for a user to locate relevant content from a particular third-party publisher of relevance to the user, such as from the user's mobile operator or device manufacturer. Due to this difficulty, the user may be unaware of content offers to which the user is entitled. Further, the mobile operators and device manufacturers cannot effectively utilize the application catalog to present valuable content to their users.

### SUMMARY

Systems and methods for integrating third-party content and first-party content in a marketplace environment for presentation to a user of a computing device are provided. The method may include receiving content and publisher-specific metadata from a plurality of third-party publishers; storing the content and publisher-specific metadata in a catalog database. The database may include third-party publisher content and first-party content. The method may further include receiving a catalog query from a client device, identifying a set of catalogs to which a user of the client device belongs; generating query results, the query results including third-party publisher content and first-party content; filtering query results based on the metadata and set of catalogs; and sending the filtered query results to the client device for display on the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an embodiment of a computing system in accordance with this disclosure.

FIG. 2 shows an embodiment of a communication method for integrating third-party content and general content in a marketplace environment for presentation to a user of a computing device.

FIG. 3 shows an example embodiment of a graphical user interface on a client device of the system of FIG. 1, in accordance with this disclosure.

FIG. 4 shows another example embodiment of a graphical user interface on a client device of the system of FIG. 1, in accordance with this disclosure.

### DETAILED DESCRIPTION

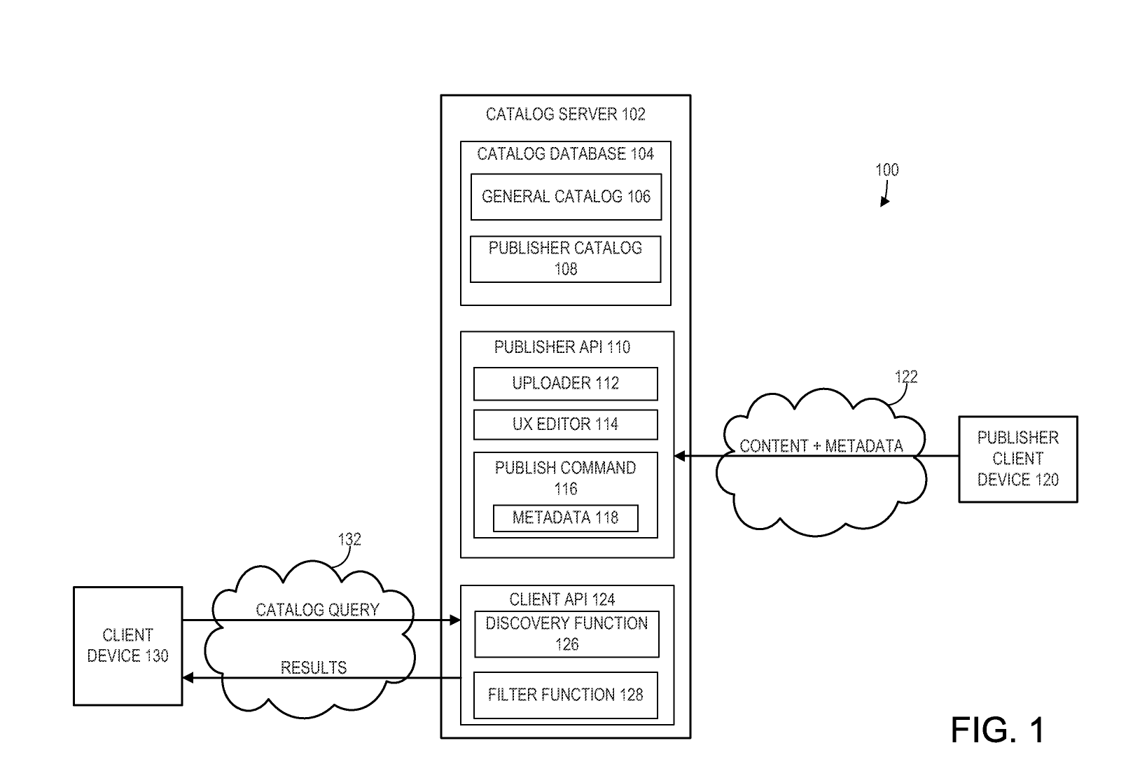

Turning now to FIG. 1, an embodiment of a computing system 100 in accordance with this disclosure is schematically shown in simplified form.

Computing system 100 includes a catalog server 102. The catalog server 102 includes a catalog database 104 configured to store digital content such as applications, games, music, videos, and the like, provided by first-party publishers and third-party publishers. For example, a first-party publisher may be a manufacturer or a provider of an operating system running on a client device, such a client device 130, which interfaces with catalog server 102 via network 132. Examples of third-party publishers include mobile operators, device manufacturers, carrier service providers, wireless service providers, network providers, etc. Network 132 is typically a WAN, and may for example, include the Internet, and is accessed via a client-side access network, such as a digital subscriber line (DLS) network, cable operator network, mobile operator network, etc.

The catalog database includes a general catalog 106 and a publisher catalog 108. The general catalog includes content provided by a first-party publisher. For example, a manufacturer of an operating system running on client device 130 may provide content via catalog server 102 to a user of client device 130. Such first-party publisher provided content is referred to herein as general content which may be stored in the general catalog 106. Further, content in the catalog database 104 may be periodically updated by both first and third-party publishers. For example, an operating system manufacturer may publish new applications, operating system components, drivers, etc.

There may be a business desire for a computing device operating system manufacturer to support exclusive content offers by third-party content publishers, such as internet access network operators (including mobile operators, cable operators, DSL operators, satellite operators, etc.) in addition to first-party or general content. Additionally, an access network operator may wish to provide incentives for users to be a part of their user base by offering special content and discounts on content etc.

In order to properly offer third-party exclusive content, such as electronic media and applications as discussed above, to users, e.g., a user of client device 130, users may need to be identified as fulfilling various publisher-specific requirements set forth by a third-party publisher of content. Examples of publisher-specific requirements may include access rules dictating addition or removal of content and/or special pricing information provided to users in a user base. Further, it may be desirable to provide a user with a combination of content offered by the general catalog in addition to the content offered by third-party publishers so that a user may browse and possibly purchase or view the content. Further, in some examples, a third-party publisher may wish to restrict the contents of a catalog provided to a user in order to limit general items from being displayed to a user. As such, it may be desirable to present a filtered unified view of the first and third-party catalogues to a user.

Thus, the catalog server 102 includes a publisher API 110 which provides an interface for third-party publishers to provide content to the catalog database 104 together with various publisher-specific metadata such as access rules and pricing information.

As such, the publisher API includes an uploader 112 configured to receive content from a publisher client device, e.g., publisher client device 120, via network 122, so that the content may be uploaded and stored in catalog database 104.

The publisher API 110 further includes a publish command 116 for publishing publisher-uploaded content and metadata 118 in catalog database 104. Publisher specific metadata may include various access rules and pricing information assigned to the uploaded content. For example, third-party publishers may wish to offer exclusive availability and/or pricing of content to users in their user base. For example a third-party publisher may mark an uploaded item, via metadata, as being available to select applicable users. For example, a mobile network operator may offer a mapping application exclusively to its subscribers. Additionally, third-party publishers may desire to specify content, e.g., content in a general catalog, which is blocked from their users. For example, a mobile operator may block competing mapping applications from the general catalog. For example, a publisher may offer price differential information, via the metadata, so that content may be offered to a first set of users at a first cost and offered to a second set of users at a second different cost. For example, a third-party publisher may offer discount for content to users in their user base. For example, a mobile operator may offer its mapping application for free to its premier subscribers, but charge its regular subscribers half price, and charge non-subscribers full price.

Namely, a third-party publisher or content owner may have distribution rules that they wish to apply to their content, e.g., special prices on content in the general catalog, access to new content that does not exist in the general catalog, or they may want to prevent purchase or viewing by their users of content that is included in the general catalog. In some examples, a potential third-party publisher may search the general catalog for content, negotiate a deal with the owner of the general content, and offer special prices or exclusive availability for the content. For example, a publisher may offer higher quality versions of the content, exclusive availability of the content, or selectively remove content for users in their user base. In this way a third-party publisher may customize content presented to their user base.

As remarked above, the metadata received by the catalog server 102 from a publisher may indicate exclusive availability and/or exclusive pricing assigned to the content. The metadata may additionally include an indication of which catalogues of which the content is to be a part. For example, the content may be specified to belong in only the general content, only a third-party catalog, or both the general catalog and a third-party catalog. In this example, the metadata may also include pricing information such as a first price for content included in the general catalog, a second price for content in the third-party catalog, and/or a price differential for content that is included in both catalogues.

The publisher-specific metadata may be represented in an xml schema that is read into the catalog server. For example, publisher uploaded content may be wrapped in xml code when uploaded. The xml may also include data indicating which catalogues the uploaded content is to be included in one, e.g., the general catalog or a third-party catalog. Namely, the logic of the xml schema that is being used to upload the content may include data on whether or not there is to be a price differential if the content is to be included the general catalog for the entire user base, whether content in the general catalog is to be removed, and/or which catalogues new content is to be included in.

The general and third-party content may be displayed to a user of a client device, e.g., client device 130, in a marketplace environment wherein the user may browse available content. A third-party content publisher may further customize or brand a marketplace store by providing various user experience (UX) customizations, which are customizations to the graphical user interface that alter the user experience with the software. For example, a third-party may customize the catalog from the publishing side by choose how a catalog is altered from a publishing aspect to affect how it gets rendered on a client device following a query from a user of the client device.

A third-party publisher may customize a marketplace in a variety of ways. For example, a third-party may provide a publisher-specific background image and select content to be featured in a catalog presented to a user. For example, in a display of a catalog or marketplace on a client device, there may be a set of featured content prominently display to a user, in a pivot GUI element for a user to browse through. In this way a third-party publisher may customize portions of a user interface.

Such customizations may be performed via a UX editor 114 in publisher API 110 where a third-party publisher sends customizations via publisher client device 120 through network 122 to catalog server 102. For example, a publisher may have their own featured section controlled by the UX editor. Thus UX editor 114 in publisher API 110 may include an upload function background images and may receive featured content lists from a third-party publisher. It will be appreciated that the UX editor may also be referred to as a GUI editor because it is used to edit the GUI displayed on the client device to customize the user experience.

The catalog database 104 may include content from a plurality of third-party publishers in addition to the first-party publisher. Thus, there may be a plurality of featured sections displayed to a user on the client device, typically with one featured section controlled by each publisher.

Catalog server 102 also includes a client API 124 for interfacing with client device 130. The client API includes a discovery function 126 for identifying catalogues to which a user of the client device is allowed access.

The discovery function 126 includes set of variables and values used to detect users who should be offered specific third-party content, e.g., as specified by a third-party publisher. When a client connects to the marketplace, the first step is to pass these values through a configuration step and the client will be returned a list of API endpoints and a list of third-party catalogs they have access to.

Thus, when customers of a third-party desired to view their catalogs they are provided with a hybrid view of what they would be offered from their provider in addition to what they are offered by a general catalog. Thus, customers of a third-party get a hybrid experience dictated by a first-party, e.g., an OS manufacturer, along with whatever customization that third-party adds.

The client device 130 may be any suitable computing device, e.g., a mobile device such as a cell phone, PDA, or a personal computer, and interacts with the catalog server 102 via a network 132. The client device may be used to access multiple stores or catalogues with content from multiple publishers.

The discovery function 126 is configured to receive data from the client device to determine what type of user and which third-parties it is a customer of. Namely, the client device may store identification information, e.g., in a SIM card, and pass that information to the catalog server. For example, a call to a service on the catalog server may be performed by an http request where the URL of that request included appended identification and content request information.

The client device sends catalog queries to catalog server 102 via network 132 to request content from catalog database 104. The catalog server then generates query results and filters the results to send to the client for display in a marketplace environment. Only content that applies to the users of the client device will be returned after filtering, depending on which third parties the user is a member of and what customizations the third-parties have provided. The catalog server 102 then sends the filtered results to the client device to be display in a graphical user interface on the client device.

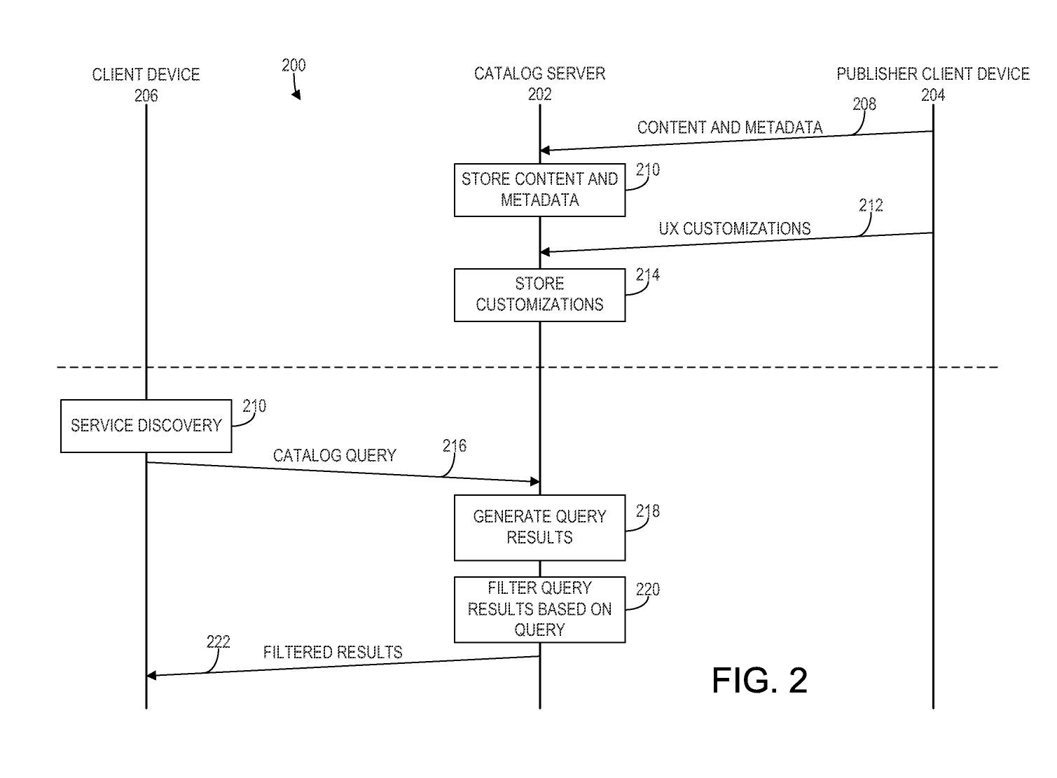

FIG. 2 shows an embodiment of a communication method 200 for integrating third-party content and general content in a marketplace environment for presentation to a user of a computing device. The example communication method shown in FIG. 2 shows a publisher client device 204 communicating with a catalog server 202 to upload content, metadata, and customizations and a client device 206 communicating with the catalog server 202 to query a catalog for display on the client device.

The method shown in FIG. 2 may be implemented by a plurality of different third-party publishers via a plurality of different publisher client devices. Additionally, a plurality of different client devices may use the method to request content from catalog server 202.

At 208, method 200 includes receiving content and publisher specific metadata from a publisher client device. As discussed above, the metadata may include publisher specified access rules, content pricing, and other publisher-specified customizations.

At 210, method 200 includes storing the content and metadata in a catalog database, where the database includes third-party publisher content and first-party publisher content.

As described above, in some examples, a third-party publisher may send a variety of customizations to the catalog server in order to brand a marketplace environment displayed to a user of a client device. Thus, at 212 method 200 may include receiving customizations from the publisher client device. The customizations may include publisher specified background images and publisher specified feature content, for example. At 214, method 200 includes storing the customizations in the catalog server.

The client device may then submit queries to the catalog server for content. In order to determine which content a user of client device 206 is a member of, at 210, method 200 includes a service discovery step as described above.

At 216, method 200 includes receiving a catalog query from client device 206. The catalog query includes subscription information of a user of the client device and may be performed via an http request as described above.

At 218 method 200 includes generating query results where the query results include third-party content and first-party content. At 220, method 200 includes filtering the query results based on the publisher-specific metadata and which catalog the user is part of. In some examples, the filtered query results may include differential pricing information for publisher content and general content.

At 222, method 200 includes sending the filtered query results to the client device for display on the client device, e.g., in a marketplace environment or graphical user interface (GUI) on the client device. The display may present a combination of the content offered by the first-party and third parties in a combined view.

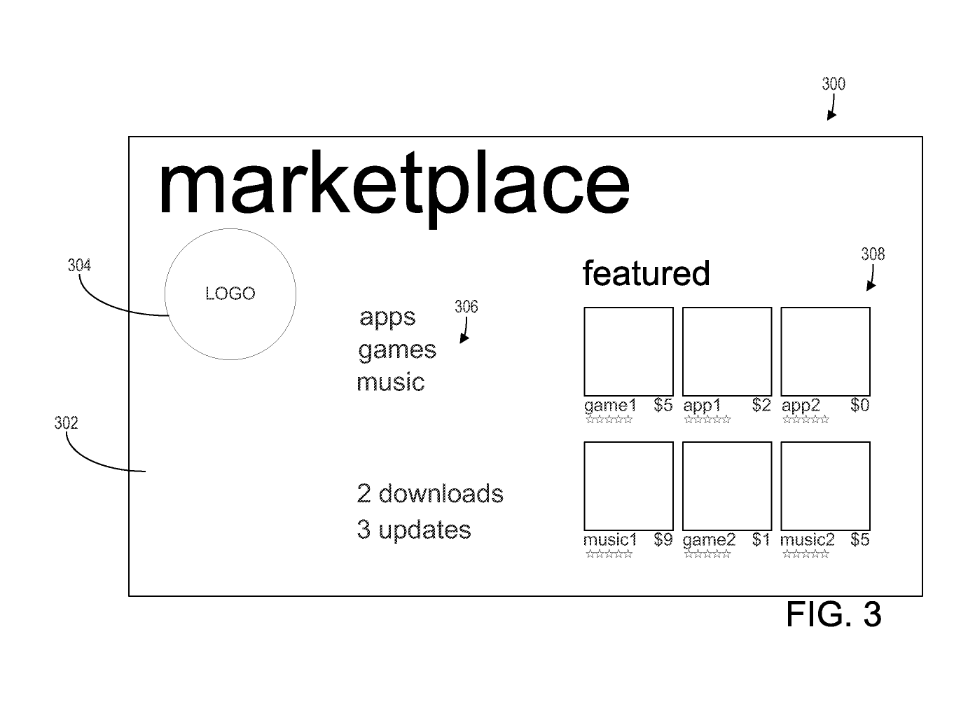

FIG. 3 shows an example embodiment of a graphical user interface 300 on a client device in accordance with this disclosure. GUI 300 may be a marketplace environment or catalog displayed to user of a client device in response to a catalog query and may include various third-party customizations, for example, a third party provided background image 302 including a logo 304 and/or various text, or other customizations.

The marketplace environment may include various browsing functions such as directories 306 together with content 308. For example the content 308 shown in FIG. 3 may be featured content as specified by a third-party.

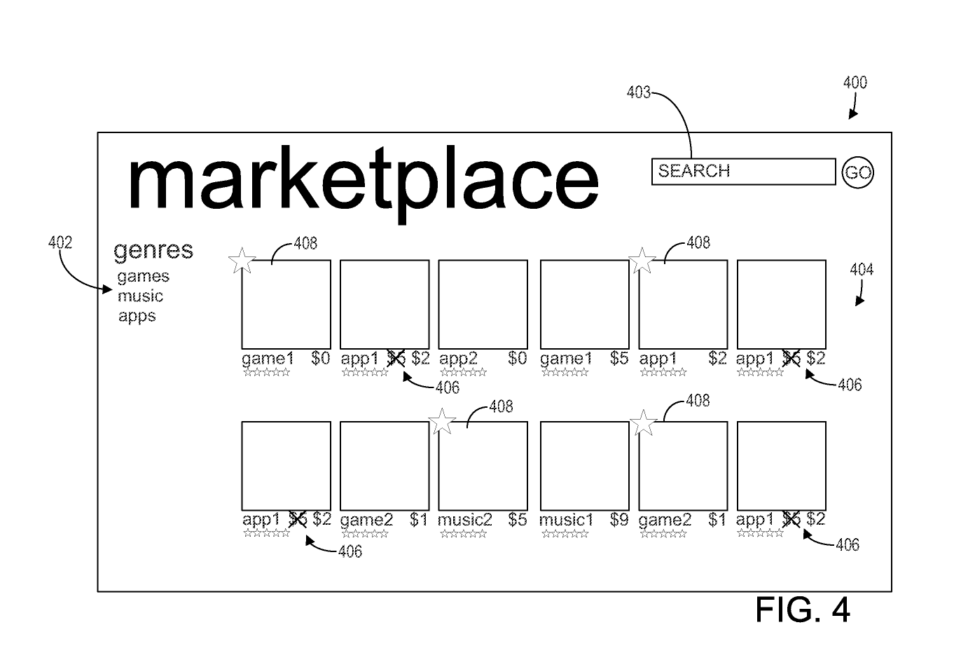

FIG. 4 shows another example embodiment of a graphical user interface 400 on a client device in accordance with this disclosure. GUI 400 may be a marketplace and may include various customizations provided by a publisher to brand the market place.

The marketplace may include various browsing functions such as directories 402, a search box 403 together with content 404. In some examples, content from a plurality of different publishers may be included with price differentials 406 indicating discounted pricing available to subscribers of a third-party service, for example. The marketplace displays a hybrid view of content from a plurality of publishers in addition to general content and may additionally featured content 408.

Each computing device disclosed herein includes a physical processor and an associated memory and mass storage device. The processor is configured to execute software stored on the mass storage device using portions of memory to implement the functions described above. In some embodiments, the processor and memory may be integrated on a single chip. Each computing device may optionally include a user input device, such as a keyboard, touchpad, touch screen, or mouse, and a display. Each computing device may further include a network communication system configured to enable the device to communicate with other devices over wired and/or wireless networks, including the Internet. The computing device may further include computer readable media storing instructions that when executed by the processor cause the computing device to perform the functions recited above

It is to be understood that virtually any computer architecture may be used without departing from the scope of this disclosure. In different embodiments, computing system 100 may take the form of a mainframe computer, server computer, desktop computer, laptop computer, tablet computer, home entertainment computer, network computing device, mobile computing device, mobile communication device, gaming device, etc. The methods and processes described below herein may be implemented as a computer application, computer service, computer API, computer library, and/or other computer program products

It is to be appreciated that a data-holding subsystem includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of a computing device that is implemented to perform one or more particular functions. In some cases, such a module, program, or engine may be instantiated via a processor executing instructions held by memory or mass storage. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for operating a content marketplace server, the method comprising:
receiving content and publisher-specific metadata from a plurality of third-party publishers;
storing the content and publisher-specific metadata in a catalog database, the database including third-party publisher content and first-party content;
receiving a catalog query from a client device;
identifying a set of catalogs to which a user of the client device belongs;
generating query results, the query results including third-party publisher content and first-party content;
filtering query results based on the metadata and set of catalogs; and
sending the filtered query results to the client device for display on the client device.

2. The method of claim 1, wherein at least one of the third-party publishers is a mobile operator or a device manufacturer.

3. The method of claim 1, wherein the metadata includes third-party publisher specified access rules and content pricing.

4. The method of claim 1, wherein the metadata is an xml schema.

5. The method of claim 1, wherein the catalog query includes subscription information of a user of the client device.

6. The method of claim 1, wherein the catalog query is an http request.

7. The method of claim 1, wherein the content includes one or more of an application, a video, and music.

8. The method of claim 1, further comprising receiving customizations from at least one of the plurality of third-party publishers, storing the customizations, and wherein sending the filtered query results to the client device includes sending the customizations to the client device.

9. The method of claim 8, wherein the customizations include a publisher specified background image and publisher specified featured content.

10. The method of claim 1, wherein the filtered query results include differential pricing information for third-party publisher content and general content.

11. A computing device configured as a content marketplace server, comprising:
a logic subsystem; and
a data holding subsystem comprising machine-readable instructions stored thereon that are executable by the logic subsystem to:
receive content and publisher-specific metadata from a plurality of third-party publishers;
store the content and publisher-specific metadata in a catalog database, the database including third-party publisher content and first-party content;
receive a catalog query from a client device;
identify a set of catalogs to which a user of the client device belongs;
generate query results, the query results including third-party publisher content and first-party content;
filter query results based on the metadata and set of catalogs; and
send the filtered query results to the client device for display on the client device.

12. The computing device of claim 11, wherein the metadata includes third-party publisher specified access rules and content pricing.

13. The computing device of claim 11, wherein the catalog query includes subscription information of a user of the client device.

14. The computing device of claim 11, wherein the data holding subsystem comprising machine-readable instructions stored thereon that are executable by the logic subsystem is further configured to: receive customizations from at least one of the plurality of third-party publishers, store the customizations, and wherein sending the filtered query results to the client device includes sending the customizations to the client device.

15. The computing device of claim 11, wherein at least one of the third-party publishers is a mobile operator or a device manufacturer.

16. A graphical user interface running on a client device configured to:
send a catalog query to a catalog server, the catalog query including subscription information of a user of the client device;
receive query results from the catalog server, the query results including first-party content and third-party publisher content, the third-party publisher content from a plurality of third-party publishers and including publisher specified metadata; and
display the first-party content and third-party publisher content based on the metadata and subscription information.

17. The graphical user interface of claim 16, wherein the metadata includes third-party publisher specified access rules and content pricing.

18. The graphical user interface of claim 16, wherein the graphical user interface is further configured to display third-party publisher customized content.

19. The graphical user interface of claim 18, wherein the third-party publisher customized content includes a publisher specified background image and publisher specified featured content.

20. The graphical user interface of claim 16, wherein the graphical user interface is further configured to display differential pricing information for third-party publisher content and first-party content.
